(19) United States
(12) Patent Application Publication
(10) Pub. No.: US 2003/0107210 A1
(43) Pub. Date: Jun. 12, 2003

(54) Car safety belt having power source and communication wire

(76) Inventor: Liao Sheng Hsin, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/006,147

(22) Filed: Dec. 10, 2001

(51) Int. Cl. B60R 22/48

(52) U.S. Cl. 280/801.1

(57) ABSTRACT

The present invention provides a car safety belt having a power source and communication wire, wherein the power source and communication wire is disposed on the car safety belt. One end of the power source and communication wire is connected to a first connector, while the other end thereof is connected to a second connector and/or a communication device like an earphone or a loudspeaker. In the present invention, the power source and communication wire is fixed on the safety belt so that the power source and communication wire can be well positioned and will not swing. Therefore, a user will not be disturbed when he is driving a car, hence effectively enhancing the driving safety.

### FIELD OF THE INVENTION

The present invention relates to a car safety belt having a power source and communication wire and, more particularly, to a car safety belt having a power source and communication wire, which will not disturb a driver when he is driving a car so as to effectively enhance the driving safety.

### BACKGROUND OF THE INVENTION

Along with continual progress of information technology, the probability of people using portable electronic devices increases gradually. As shown in FIG. 1, a communication wire 30a is used to connect a prior art portable electronic device 10a with a hand-free earphone 20a (or a common earphone or microphone) so that the communication wire 30a can transfer signals of the portable electronic device 10 to the earphone 20a.

However, because the communication wire 30 is exposed outside, in addition to swing, a user's action will be disturbed. The user may carelessly pull and drag the communication wire 30a, resulting in inconvenience in action and work. Especially, the driving safety will be much affected when the user is driving a car.

Moreover, safety belts are generally disposed at the front seats of a common car. However, a car safety belt only has the single function of tying a person on the seat, but cannot provide other accessory functions.

Accordingly, the above communication wire has inconvenience and drawbacks in practical use. The present invention aims to resolve the problems in the prior art.

### SUMMARY OF THE INVENTION

The primary object of the present invention is to provide a car safety belt having a power source and communication wire, wherein the power source and communication wire is fixed on the safety belt so that the power source and communication wire can be well positioned and will not swing. Therefore, a user will not be disturbed when he is driving a car, hence effectively enhance the driving safety.

To achieve the above object, the present invention provides a car safety belt having a power source and communication wire, wherein the power source and communication wire is disposed on the car safety belt. One end of the power source and communication wire is connected to a first connector, while the other end thereof is connected to a second connector and/or a communication device. The communication device can be an earphone, a loudspeaker, or a microphone.

The various objects and advantages of the present invention will be more readily understood from the following detailed description when read in conjunction with the appended drawing, in which:

### BRIEF DESCRIPTION OF THE DRAWINGS

FIG. 1 is a diagram showing the use state of a prior art communication wire;

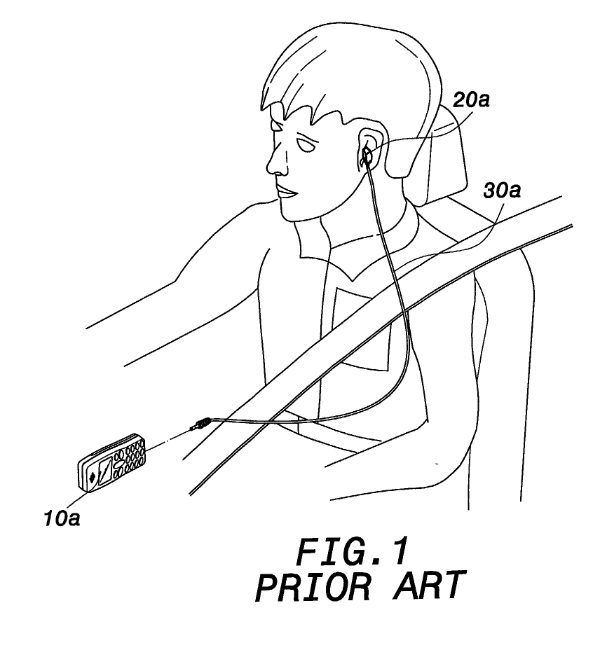

FIG. 2 is a perspective view of a first embodiment of the present invention;

FIG. 3 is a diagram showing the use state of the first embodiment of the present invention;

FIG. 4 is a perspective view of a second embodiment of the present invention;

FIG. 5 is a diagram showing the use state of the second embodiment of the present invention;

FIG. 6 is a diagram showing the use state of a third embodiment of the present invention;

FIG. 7 is a perspective view of a fourth embodiment of the present invention;

FIG. 8 is a diagram showing the use state of a fifth embodiment of the present invention;

FIG. 9 is a diagram showing the use state of a sixth embodiment of the present invention;

FIG. 10 is a diagram showing the use state of a seventh embodiment of the present invention; and

FIG. 11 is a perspective view of a eighth embodiment of the present invention.

### DETAILED DESCRIPTION OF THE PREFERRED EMBODIMENTS

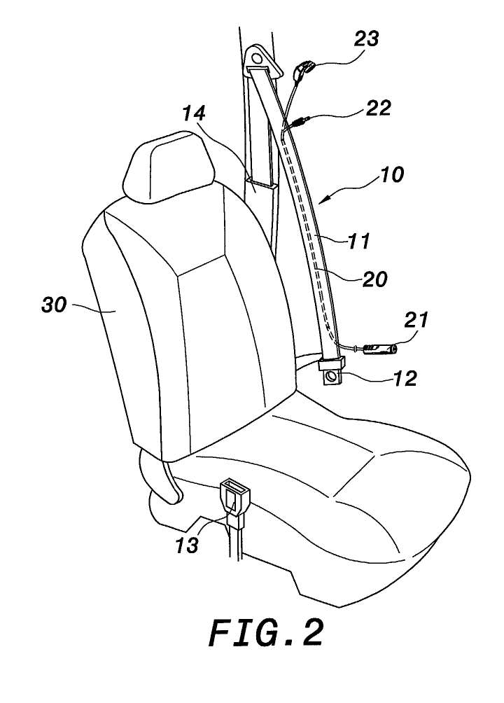

As shown in FIG. 2, the present invention provides a car safety belt having a power source and communication wire. A general car safety belt 10 is disposed at two sides of a car seat 30. The safety belt 10 comprises a retractable belt body 11, a first buckling element 12, and a second buckling element 13. The belt body 11 can be resiliently pulled out from or retract into a receiving seat 14 disposed at one side of the car seat 30. The first buckling element 12 is connected at one end of the belt body 11. The second buckling element 13 is fixed at the other side of the car seat 30. After the belt body 11 ties up a person on the car seat 30, the first buckling element 12 is inserted into the second buckling element 13 so that the belt body 11 can stably tie up the person. The structure of the above safety belt is the same as that in the prior art and thus will not be further described.

In the present invention, a power source and communication wire 20 is disposed on the car safety belt 10. The power source and communication wire 20 passes through the inside of the belt body 11 of the safety belt 10. One end of the power source and communication wire 20 is connected to a first connector 21, while the other end thereof is connected to a second connector 22 and a communication device like an earphone 23. The first connector 21, the second connector 22, and the earphone 23 protrude out of the belt body 11. A car safety belt having a power source and communication wire of the present invention is thus formed.

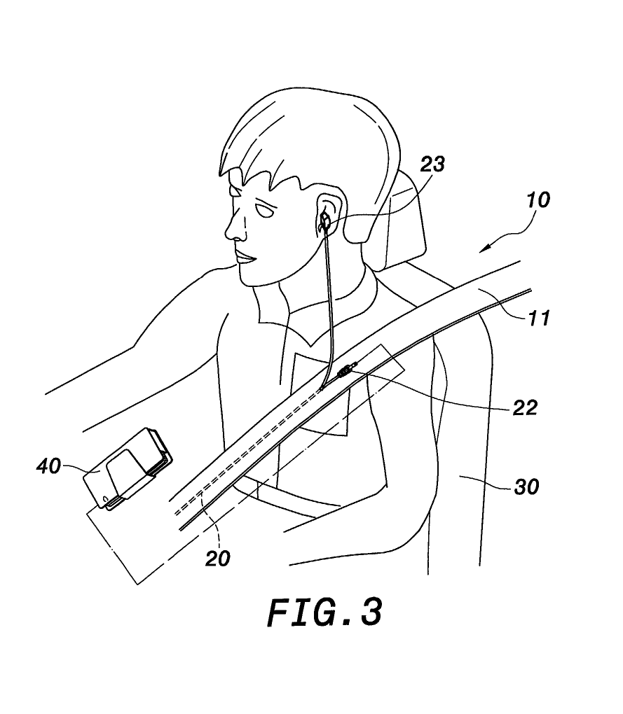

As shown in FIG. 3, the power source and communication wire 20 of the present invention is disposed on the safety belt 10. The power source and communication wire 20 can be used to connect a portable electronic device 40, a hand-free earphone 23, and a charging device. The portable electronic device 40 of this embodiment is a mobile phone. The portable electronic device 40 is plugged with the second connector 22. The power source and communication wire 20 can thus be connected between the portable electronic device 40 and the earphone 23 so that signals of the portable electronic device 40 can be transferred to the earphone 23 via the power source and communication wire 20. Besides, the first connector 21 can be plugged with the charging device (not shown) to provide the required electricity for the portable electronic device 40 and to charge it.

In the present invention, the power source and communication wire 20 is fixed on the safety belt 10 so that it can be well positioned and will not swing. A user will not be disturbed when he is driving a car, hence effectively enhancing the driving safety.

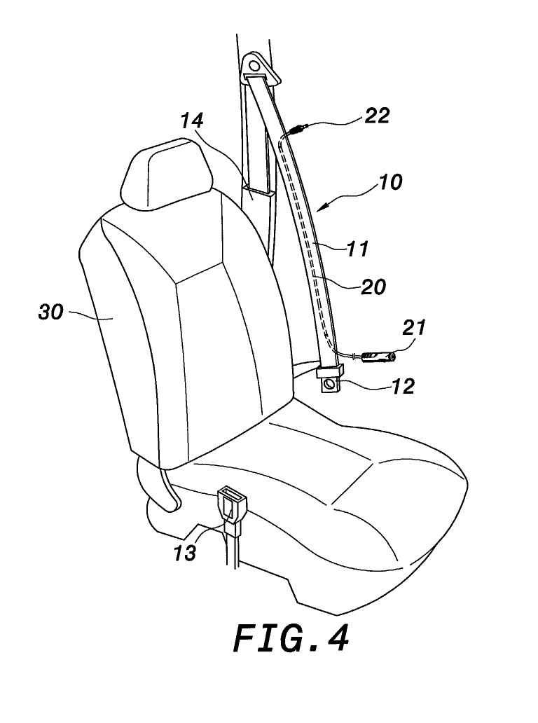

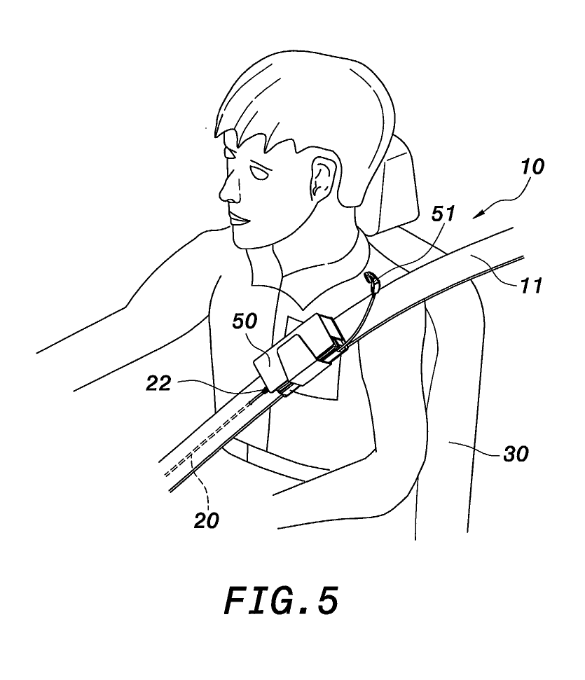

As shown in FIGS. 4 and 5, the other end of the power source and communication wire 20 can also be only connected to a second connector 22. The power source and communication wire 20 can be used to connect a portable electronic device 50, a hand-free earphone 51, and a charging device. The portable electronic device 50 of this embodiment is a mobile phone. The portable electronic device 50 is connected to a communication device like a hand-free earphone 51. The portable electronic device 50 can be fixed on the belt body 11 of the safety belt 10. The portable electronic device 50 is plugged with the second connector 22 so that the power source and communication wire 20 can be connected to the portable electronic device 50. The first connector 21 can be plugged with the charging device (not shown) to provide the required electricity for the portable electronic device 50 and to charge it.

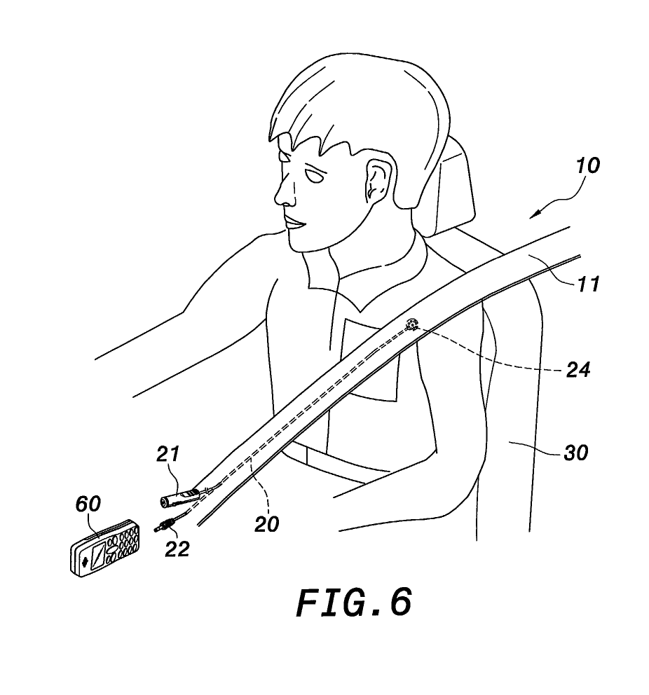

As shown in FIG. 6, one end of the power source and communication wire 20 of the present invention can be connected to a first connector 21 and a second connector 22 simultaneously, and the other end thereof is connected to a communication device like a loudspeaker 24. The power source and communication wire 20 can be used to connect a portable electronic device 60, a loudspeaker 24, and a charging device. The portable electronic device 60 of this embodiment is a mobile phone. The portable electronic device 60 is plugged with the second connector 22. The power source and communication wire 20 can thus be connected between the portable electronic device 60 and the loudspeaker 24 so that signals of the portable electronic device 60 can be transferred to the loudspeaker 24 via the power source and communication wire 20. The first connector 21 can be plugged with the charging device (not shown) to provide the required electricity for the portable electronic device 60 and to charge it.

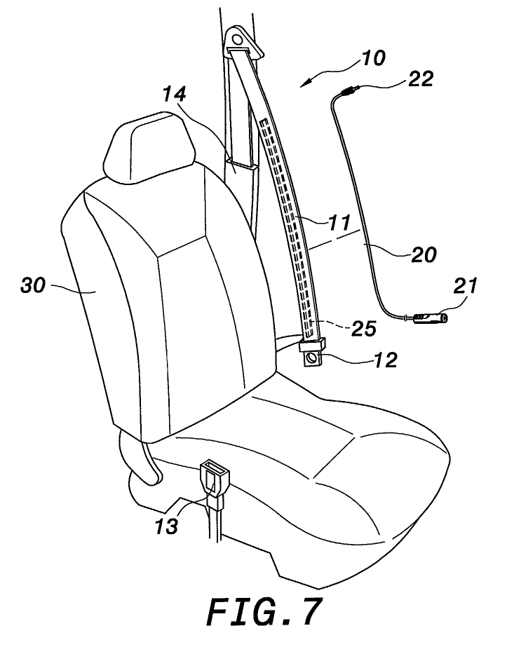

As shown in FIG. 7, the power source and communication wire 20 of the present invention can be fixed outside the belt body 11 of the safety belt 10 in detachable way. The power source and communication wire 20 is sheathed and fixed outside the belt body 11 by using a fixing element 25 like a buckling band to facilitate assembly and replacement of the power source and communication wire 20.

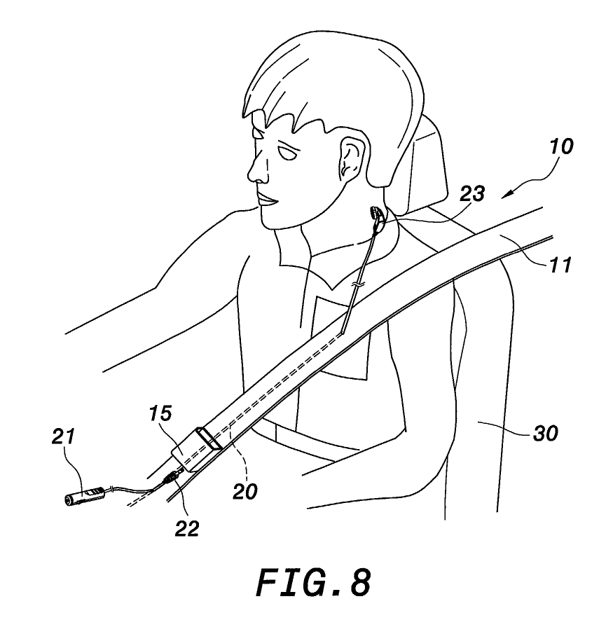

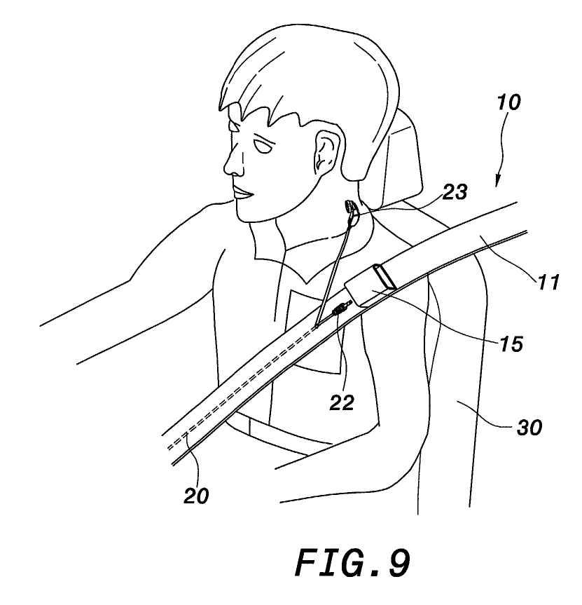

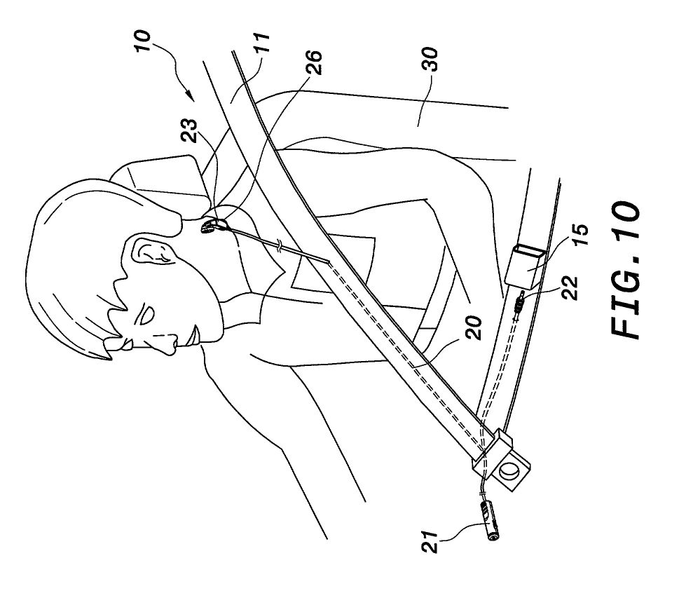

As shown in FIGS. 8, 9, and 10, a placement seat 15 can be fixed outside the belt body 11 of the safety belt 10. The placement seat 15 can be fixed at an arbitrary position on the belt body 11. The placement seat 15 is used to place a portable electronic device like a mobile phone. Besides, as shown in FIG. 10, the other end of the power source and communication wire 20 can be connected to a microphone 26.

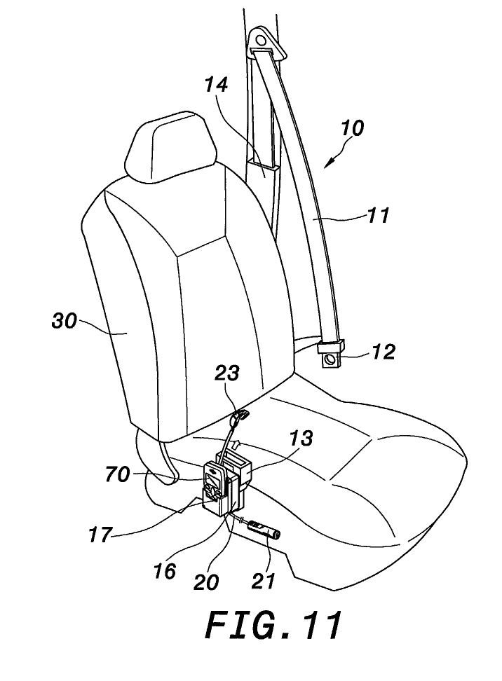

As shown in FIG. 11, the power source and communication wire 20 of the present invention can be resiliently rewound into a winder 16. The first connector 21 and the communication device like the earphone 23 are connected to two ends of the power source and communication wire 20, respectively. The winder 16 is fixed at the outer side of the second buckling element 13 of the safety belt 10. The winder 16 can rewind and receive the power source and communication wire 20 of considerable length. The power source and communication wire 20 and the earphone 23 can be pulled out from the winder 16. The power source and communication wire 20 is acted on by a spiral reed (not shown) to keep a certain tensile force so that it can be successfully rewound. Entanglement of the power source and communication wire 20 due to a too long length or inconvenient usage due to a too short length thus will arise. Moreover, a placement seat 17 is disposed at the outer side of the winder 16, and conductive elements (not shown) are disposed inside the placement seat 17 to achieve electric connection with the power source and communication wire 20. The placement seat 17 can be used to place a portable electronic device 70 like a mobile phone. The portable electronic device 70 can achieve electric connection with the power source and communication wire 20 via the conductive elements (not shown). The power source and communication wire 20 can thus be connected between the portable electronic device 70 and the earphone 23 so that signals of the portable electronic device 70 can be transferred to the earphone 23 via the power source and communication wire 20. Besides, the first connector 21 can be plugged with a charging device (not shown) to provide the required electricity for the portable electronic device 70 and to charge it.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A car safety belt having a power source and communication wire, wherein said power source and communication wire is disposed on said car safety belt, one end of said power source and communication wire being connected to a first connector, the other end thereof being connected to a second connector and/or a communication device.

2. The car safety belt having a power source and communication wire as claimed in claim 1, wherein said safety belt comprises a retractable belt body, a first buckling element, and a second buckling element, said first buckling element being connected to one end of said belt body, said first buckling element being inserted into said second buckling element, said power source and communication wire being disposed on said belt body or said second buckling element.

3. The car safety belt having a power source and communication wire as claimed in claim 1, wherein a placement seat for a portable electronic device is disposed on said safety belt.

4. The car safety belt having a power source and communication wire as claimed in claim 1, wherein said power source and communication wire is disposed inside or outside said safety belt.

5. The car safety belt having a power source and communication wire as claimed in claim 1, wherein said power source and communication wire is fixed on said safety belt in detachable way.

6. The car safety belt having a power source and communication wire as claimed in claim 1, wherein one end of said power source and communication wire can be further connected to a connector.

7. The car safety belt having a power source and communication wire as claimed in claim 1, wherein said power source and communication wire is resiliently rewound in a winder, and said winder is fixed on said safety belt.

8. The car safety belt having a power source and communication wire as claimed in claim 1, wherein said communication device can be an earphone, a loudspeaker, or a microphone.
